(19) United States
(12) Patent Application Publication
(10) Pub. No.: US 2026/0304225 A1
(43) Pub. Date: Oct. 1, 2026

(54) METHOD AND APPARATUS FOR TRANSMITTING DATA IN A WIRELESS COMMUNICATION SYSTEM

(71) Applicant: SAMSUNG ELECTRONICS CO., LTD., Suwon-si, Gyeonggi-do (KR)

(72) Inventor: Donggun KIM, Staines, Middlesex (GB)

(21) Appl. No.: 18/996,565

(22) PCT Filed: Aug. 18, 2023
(86) PCT No.: PCT/KR2023/012233

§ 371 Date: Jan. 17, 2025

(30) Foreign Application Priority Data
Aug. 23, 2022 (GB) 2212241.0
Jul. 26, 2023 (GB) 2311483.8

(51) Int. Cl. H04W 28/06; H04L 69/321; H04W 12/037; H04W 28/02

(52) U.S. Cl. CPC H04W 28/065; H04L 69/321; H04W 12/037; H04W 28/0268

(57) ABSTRACT

The disclosure relates to a 5G or 6G communication system for supporting a higher data transmission rate. Specifically, the disclosure related to a method performed by a transmission device in a wireless communication system. The method includes receiving, from an upper layer, a plurality of service data units (SDU)s, generating concatenated data by concatenating the plurality of SDUs before performing at least one procedure among an integrity protection procedure and a ciphering procedure for the concatenated data, and transmitting, to a reception device through a lower layer, data for which the at least one procedure has been performed, at a packet data convergence protocol (PDCP) layer. Further, the common security key information for performing the at least one procedure is applied to the SDUs included in the concatenated data.

### TECHNICAL FIELD

The present disclosure relates to wireless communication systems and, more specifically, the present disclosure relates to method and apparatus for transmitting data in a telecommunication network, particularly, but not exclusively a wireless network, such as a cellular network.

### BACKGROUND ART

5G mobile communication technologies define broad frequency bands such that high transmission rates and new services are possible, and can be implemented not only in “Sub 6GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission tech-nologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial In-telligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to method and apparatus for transmitting data in a telecommunication network, particularly, but not exclusively a wireless network, such as a cellular network.

### Solution to Problem

The present disclosure relates to a means to improve the rate of data processing, provide greater support for Artificial Intelligence/Machine Learning (AI/ML) tools and to enhance security protections applied to data in the network.

### Advantageous Effects of Invention

Aspects of the present disclosure provide efficient communication methods in a wireless communication system.

### BRIEF DESCRIPTION OF DRAWINGS

For a more complete understanding of the present disclosure and its advantages, reference is now made to the following description taken in conjunction with the ac-companying drawings, in which like reference numerals represent like parts:

FIG. 1 illustrates a prior art Control Plane Protocol Stack;

FIG. 2 illustrates a prior art User Plane Protocol Stack;

FIG. 3 illustrates an example of a User Plane protocol stack according to various embodiments of the present disclosure;

FIG. 4 illustrates a prior art of data processing function in the User Plane;

FIG. 5 illustrates an example of data processing function in the User Plane according to various embodiments of the present disclosure;

FIG. 6 illustrates a prior art data classification function in the User Plane;

FIG. 7 illustrates an example of a data classification function in the User Plane according to various embodiments of the present disclosure;

FIG. 8 illustrates a prior art data security operation in the User Plane;

FIG. 9 illustrates a selectively applied security protection operation in the User Plane according to various embodiments of the present disclosure;

FIG. 10 illustrates an overview of a protocol stack in the User Plane according to various embodiments of the present disclosure;

FIG. 11 illustrates a packetization process according to, respectively, the prior art and an embodiment of the present disclosure;

FIG. 12 illustrates a block diagram of a terminal (or a user equipment (UE), according to embodiments of the present disclosure; and

FIG. 13 illustrates a block diagram of a base station, according to embodiments of the present disclosure.

### BEST MODE FOR CARRYING OUT THE INVENTION

According to the present disclosure there is provided an apparatus and method as set forth in the appended claims. Other features of the disclosure will be apparent from the dependent claims, and the description which follows.

According to a first aspect of the present disclosure, there is provided a method for use by a transmission device in a wireless communication system. The method includes receiving, from an upper layer, a plurality of service data units, SDUs, generating concatenated data by concatenating the plurality of SDUs before performing at least one procedure among an integrity protection procedure and a ciphering procedure for the concatenated data, and transmitting, to a reception device through a lower layer, data for which the at least one procedure has been performed, at a packet data convergence protocol, PDCP, layer. Further, the common security key information for performing the at least one procedure is applied to the SDUs included in the concatenated data.

In an embodiment, the generating of the concatenated data includes generating a field including information related to the concatenation of the SDUs, and including the field in a header with the concatenated SDUs in the generated concatenated data.

In an embodiment, the concatenated data is generated in a layer above a Service Data Adaptation Protocol, SDAP, layer or a PDCP layer, and the concatenation is performed based on a quality of service, QoS, flow identifier, QFI, corresponding to an SDU.

In an embodiment, data from a particular Quality of Service flow is categorised as either data to be used as training data for training an AI model or not.

In an embodiment, both the data categorised as training data and the data not so categorised forms part of User Plane, UP, data.

In an embodiment, data arriving at or departing from an SDAP layer, a Tx and Rx layer respectively, is only partially protected.

In an embodiment, security protection in a PDCP layer is de-configured or disabled.

According to a second aspect of the present disclosure, there is provided an apparatus arranged to perform the method of the first aspect.

In an embodiment, the apparatus comprises a base station, gNB, and a User Equipment, UE, communicatively connected.

### Mode for the Invention

Although a few preferred embodiments of the present disclosure have been shown and described, it will be appreciated by those skilled in the art that various changes and modifications might be made without departing from the scope of the disclosure, as defined in the appended claims.

In the Fifth Generation (5G) or New Radio (NR) telecommunication system, data flow between the User Equipment (UE), also known as a mobile station or terminal, and the g Node B (gNB) or base station, is split between a User Plane (UP) and a Control Plane (CP). The UP carries the network user traffic. The CP includes the Radio Resource Control layer (RRC) which is responsible for configuring the lower layers.

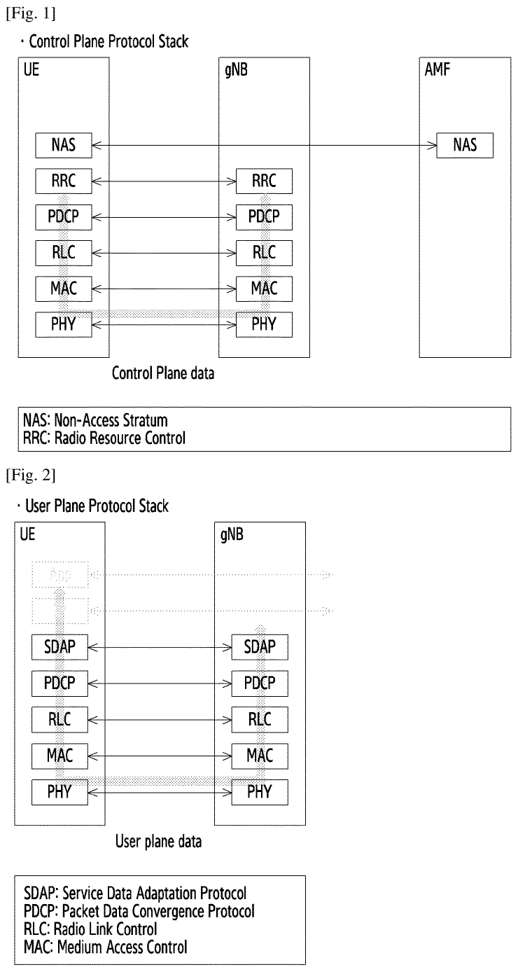

FIG. 1 through FIG. 13, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

FIGS. 1 and 2 illustrates the well-known prior art protocol stack model, each comprising several layers, for the CP and UP, respectively. FIG. 1, additionally, illustrates the Non-Access Stratum (NAS) connection between the UE and the Access and Mobility Management Function (AMF) of the network.

A particular problem associated with prior art systems concerns the speed of data throughput. In particular, evolutions in telecommunications standards require a far greater throughput of data, which prior art systems are not generally able to offer.

Combined with the need to improve security protection and support AI/ML, there is a need to greatly increase the speed of data throughput.

It is an aim of embodiments of the present disclosure to address one or more shortcomings in the prior art, whether mentioned herein or not.

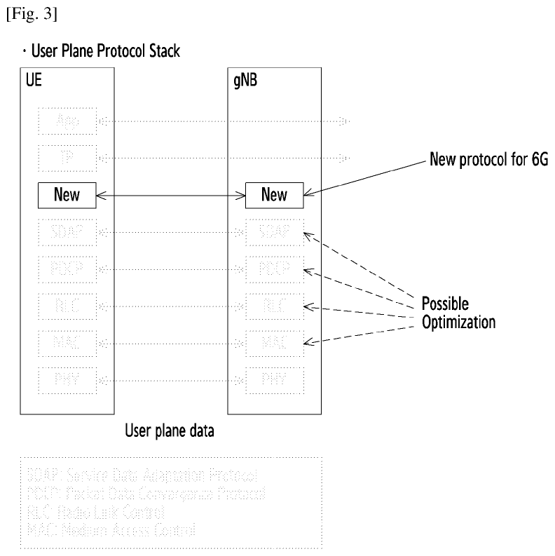

FIG. 3 illustrates an example of a User Plane protocol stack according to various embodiments of the present disclosure.

FIG. 3 shows a modified version of the protocol stack model for UP, originally shown in FIG. 2. Here, a new layer is shown located above the Service Data Adaptation Protocol (SDAP) layer. Such a layer is useful in connection with adaptations proposed or adopted in the Sixth Generation (6G) standard which su-persedes 5G and, at the time of writing, is still being finalised.

The SDAP layer is responsible for mapping between a quality-of-service (QOS) flow from the 5G core network and a data radio bearer (DRB), as well as marking the quality-of-service flow identifier (QFI) in uplink and downlink packets.

FIG. 3 also identifies SDAP, PDCP, RLC and MAC layers as possible candidates for optimisation as well as or instead of the new layer arranged above SDAP.

Amongst the requirements of the new 6G standard are a higher data rate than is possible in 5G, enhanced security of data and the ability to support increased usage of Artificial Intelligence/Machine Learning (AI/ML). Possible areas which can benefit from AI/ML applications in 6G include Air interface and transmission technologies, e.g. new waveforms; Multiple access; Channel coding; Massive Multiple-input/multiple-out (MIMO); Spectrum sharing; and Network architecture.

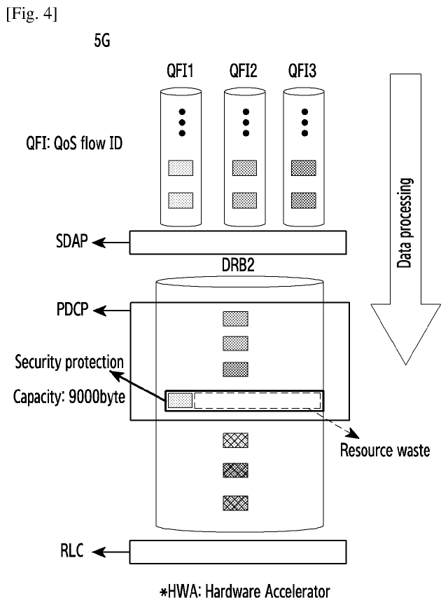

FIG. 4 illustrates a prior art of data processing function in the User Plane.

FIG. 4 shows a data processing function in the UP, according to the prior art. Specifically, it shows the situation in a 5G system. It shows a number of QoS flows (QFI1, QFI2, QFI3) being processed by the SDAP layer, mapped to a single DRB (DRB2). In the PDCP layer, security protection, such as ciphering or integrity protection, is applied to one packet of data, such as PDCP SDU. This has a size of up to 1500 byte, since this is the maximum data size supported by Ethernet. However, security protection can be applied up to a size of 9000 byte. This means that the remaining 7500 byte capacity is effectively “wasted”. This is indicated by the portion labelled “Resource Waste”.

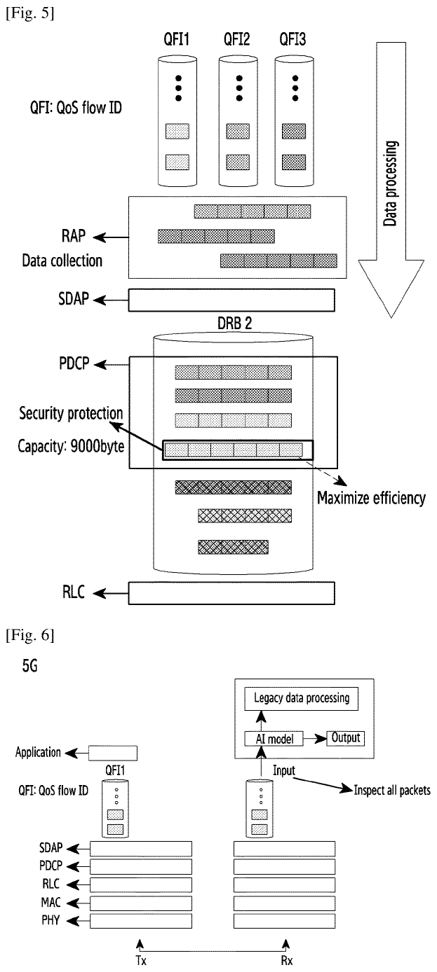

FIG. 5 illustrates an example of data processing function in the User Plane according to various embodiments of the present disclosure.

FIG. 5 shows a modified version of the function shown in FIG. 4 and is according to an embodiment of the present disclosure. It shows the introduction of a new layer RAP—Radio Analytics Protocol immediately above the SDAP. This is provided to concatenate data from the various QoS flows (QF1-QFI3). The data from these is concatenated before security protection is applied. This has the effect of maximising the utilisation rate of capacity and reduces the processing time and burden of security protection. It also has the effect of reducing header overhead, since one header is generated per one set of concatenated data, compared to one header per QFI in the prior art shown in FIG. 4.

Precisely how much data can be concatenated is configured by the network by means of a pre-defined rule or specific configuration. An AI model may, additionally or alter-natively, be employed to decide an optimal amount of data to concatenate.

In FIG. 5, the maximised efficiency of the concatenation process is illustrated as “Maximise efficiency” in the PDCP layer.

FIG. 6 illustrates a prior art data classification function in the UP. In the prior art shown, all data packets are inspected and used as possible training data for the AI model shown. This is burdensome and requires significant processing capacity and time.

All packets leaving SDAP layer are inspected by the AI model.

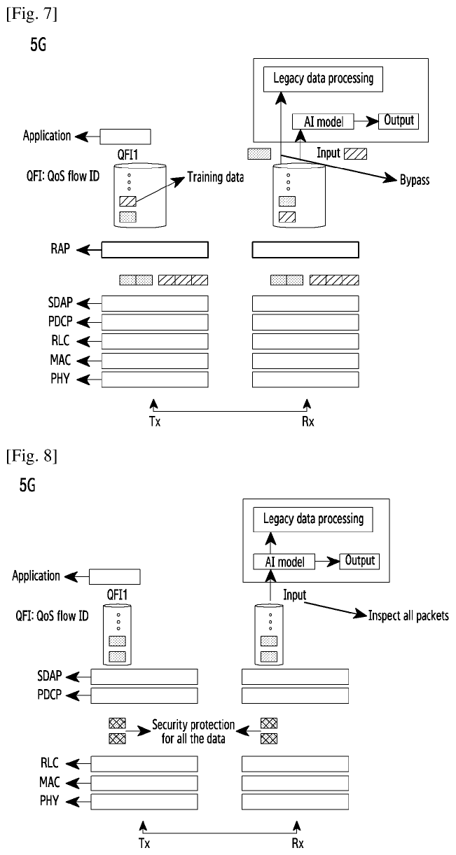

FIG. 7 illustrates an example of a data classification function in the User Plane according to various embodiments of the present disclosure.

FIG. 7 shows a modified version of the function shown in FIG. 6. Here, the Radio Analytics Protocol (RAP) is positioned above the SDAP, in both the Tx and Rx chains. In the Tx chain, the RAP acts to classify data from a QoS flow into one of two types: data to be used for training purposes and data not to be used for training purposes. All data still forms part of the UP data and is handled according to known processes, but only some of the data is now used for AI training purposes, depending on the classification applied previously by the RAP layer.

The modification to the protocol stack, and the new functionality provided by RAP, as set out in relation to FIGS. 5 and 7 may be applied independently of each other, but maximum improvement is provided if the adaptations of both FIG. 5 and FIG. 7 are applied concurrently.

FIG. 8 illustrates a prior art data security operation in the User Plane. This illustrates that all data included in the QoS flows is security protected, as illustrated by the protected data packets shown between PDCP and RLC layers. The security protection can be applied and removed as required at appropriate position in the data stream. However, security protection all the data can be burdensome and not all data necessarily requires security protection.

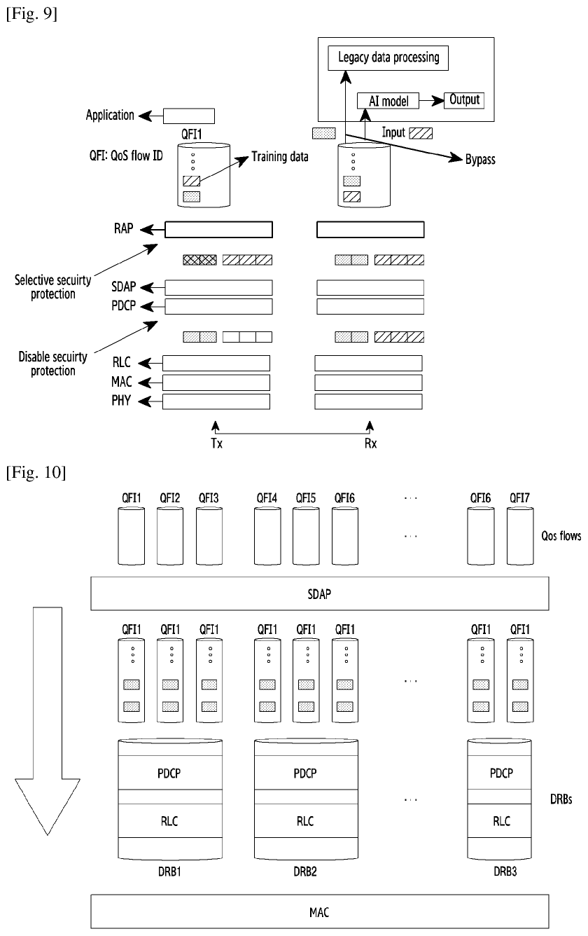

FIG. 9 illustrates a selectively applied security protection operation in the User Plane according to various embodiments of the present disclosure.

FIG. 9 shows a modified version of the security protection function of FIG. 8. The RAP layer, previously referred to, supports selective security protection by protecting only some data packets which require protection and not protecting other packets not requiring such protection.

The data packets thus arriving at SDAP in the Tx chain are only partially protected. The PDCP layer disables security protection. As the RAP layer is configured with security protection, i.e. ciphering or integrity protection, and performs security protection, the security protection in PDCP layer is de-configured or disabled by RRC reconfiguration to avoid duplicated security protection. For example, the data packets are integrity protected or ciphered in RAP layer of Tx side and submitted to the lower layers (e.g., SDAP or PDCP or RLC or MAC or PHY layer). Note that PDCP layer does not perform security protection (i.e., integrity protection or ciphering) as it was de-configured or disabled. When the data packets are received at Rx side, the lower layers process and deliver them to the RAP layer. The data packets are deciphered or integrity verified in the RAP of Rx side. Note that PDCP layer does not perform security protection (i.e., deciphering or integrity verification) as it was de-configured or disabled.

Note that data communication is peer-to-peer in this instance. If RAP layer performs security protection, then the data is protected all the way through the peer RAP layer of RX side, i.e., before deciphering or integrity verification at the peer RAP layer i.e., TX RAP->TX SDAP->TX PDCP->TX RLC->TX MAC->TX PHY->over the air->RX PHY->RX MAC->RX RLC->RX PDCP->RX RAP.

By selectively applying security protection, the AI model training is not adversely affected, since not all training data needs to be security protected. RAP protocol can support selective security protection based on RRC configuration and identifier, which significantly reduces the processing burden. In addition to this, a new security mechanism (e.g., a new algorithm) can be configured/used in RAP. In the prior art 5G system, the network can de-configure/disable the security protection from PDCP to configure or perform the security protection (e.g., the security mechanism) in RAP, meaning there is no impact on the legacy data processing, which avoids duplicate security protection in both PDCP and RAP layers.

To support data concatenation, selective security protection, or data classification as set out above, the header design and the corresponding data processing can be considered accordingly, e.g., header field indicating whether SDU is concatenated, or whether SDU is security-protected or the type of data (e.g., training data or normal user plane data).

The functions referred to above (i.e., data concatenation, selective security protection, or data classification) can be introduced in SDAP layer or PDCP layer to achieve the same purpose.

If all the functions are introduced in a layer, the order of functions can be Data classification, Data concatenation, and then selective security protection. If a few functions are introduced, they can follow the similar order.

The functions can be extended to support mobility (i.e., handover) and split bearer (i.e., UE configured with dual connectivity)

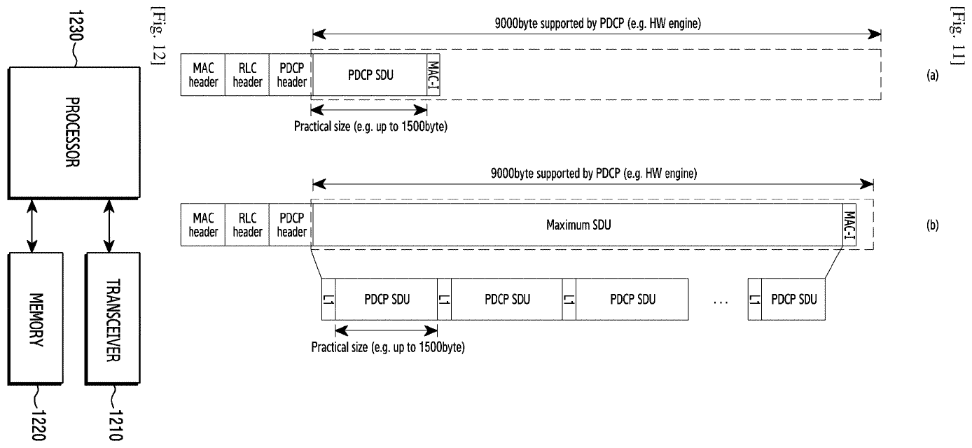

FIG. 10 illustrates an overview of a protocol stack in the User Plane according to various embodiments of the present disclosure.

FIG. 10 illustrates the inter-relation between various QoS Flows and the interaction with SDAP, PDCP, RLC and MAC layers. It illustrates the need for improvements in the data processing function required by embodiments of the present disclosure. 3 GPP standardisation restricted, in Release 15, the use of integrity protection up to 64 Kbps. However, Release 16 supports integrity protection at any data rate (e.g., 20 Gbps) as a mandatory feature. This is just one of the drivers for improved performance addressed by embodiments of the disclosure.

One of the main processing burdens results from ciphering and integrity protection, both of which are processor-intensive activities. In addition, data may be waiting to be processed before these functions are performed. It has been found, empirically, that peak data rate can be reduced by more than half if integrity protection is applied.

In order to address this issue, High Speed Packetisation (HSP) is applied, this is illustrated in FIG. 11 and FIG. 12.

The packetisation process is referred to in relation to FIGS. 4 and 5 and the so-called waster resource mentioned therein.

FIG. 11 illustrates a packetization process according to, respectively, the prior art and an embodiment of the present disclosure.

FIG. 11(a) shows the payload limited to 1500 bytes, as dictated by Ethernet, whereas FIG. 11(b) shows a maximised payload incorporating several PDCP SDUs to optimise the available payload space (which may be up to 9000 bytes).

The prior art data structure of FIG. 11(a) was designed to support fast data processing, which enables pre-processing before the reception of Uplink grant and the application of Hardware Accelerator (HWA) as shown. However, developments in the evolution of the standards means that L2 headers are added to each PDCP SDU, which incurs a large number of L2 headers to be processed at high data rate, e.g., 1.6 million L2 headers at 20 Gbps.

The User Plane Integrity Protection (UPIP) adopted from Release 16 onwards would result in significant performance degradation on data processing. Further, the data processing capacity of HWA is not fully utilized, i.e., only 1500 byte is processed, where there is a capacity of 9000 byte.

FIG. 11(b) shows HSP according to an embodiment of the disclosure. By concatenating data in this way, certain benefits are realised. These certain benefits include accelerating data processing for ciphering and integrity protection, maximizing the uti-lization rate of Hardware (HW) engine, reducing header overhead, since overall, fewer data headers are required for the same effective data, increasing data throughput.

By combining multiple PDCP SDUs into one pseudo SDU, as illustrated in FIG. 11(b) several benefits follow. The number of L2 headers to be processed is significantly reduced, as the number of concatenated SDUs increases, especially for high data rates.

The maximum SDU, including multiple PDCP SDUs, as shown, can be processed with one-time initialization and key expansion, which reduces the UPIP processing time. The UPIP performance is enhanced as the size of maximum SDU increases. Further, the data processing capacity of HWA is fully utilized, i.e., the efficiency thereof can be maximized by PDCP concatenation.

Note that in an embodiment, PDCP concatenation is an add-on feature, to be configured on top of the legacy (or prior art) configuration and is configurable by the network. Concatenated SDUs in PDCP can be regarded as one large PDCP PDU, which has no impact on legacy (or prior art) RLC/MAC/PHY.

A benefit associated with embodiments of the disclosure relates to the reduction of header overhead and processing burden. The number of L2 headers per concatenated SDUs, i.e., the number of the existing L2 headers to be processed, is reduced by 1/n times where “n” is the number of SDUs to be concatenated. SO, if e.g., 5 SDUs are concatenated, the number of L2 headers is reduced by 1/5. The resource efficiency increases as the number of concatenated SDUs increases, from the network's per-spective.

A further benefit associated with embodiments of the disclosure concerns throughput enhancement with UPIP. The concatenated SDUs can be processed with one-time initialization and one security key expansion, which reduces the processing time required. The throughput increases as the size of concatenated SDUs increases.

Furthermore, unnecessary processing delay from PDCP concatenation can be avoided or at least minimised. PDCP concatenation is applicable to the pending buffered data in a dynamic manner.

As mentioned previously, the improvement provided by HSP can be further improved by data collection and classification, security enhancement including selective security protection, and data reproduction.

FIG. 12 illustrates a block diagram of a terminal (or a user equipment (UE)), according to embodiments of the present disclosure. FIG. 12 corresponds to the example of the UE.

As shown in FIG. 12, the UE according to an embodiment may include a transceiver 1210, a memory 1220, and a processor 1230. The transceiver 1210, the memory 1220, and the processor 1230 of the UE may operate according to a communication method of the UE described above. However, the components of the UE are not limited thereto. For example, the UE may include more or fewer components than those described above. In addition, the processor 1230, the transceiver 1210, and the memory 1220 may be implemented as a single chip. Also, the processor 1230 may include at least one processor.

The transceiver 1210 collectively refers to a UE receiver and a UE transmitter, and may transmit/receive a signal to/from a base station or a network entity. The signal transmitted or received to or from the base station or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the UE. Also, the memory 1220 may store control information or data included in a signal obtained by the UE. The memory 1220 may be a storage medium, such as read-only memory (ROM), random access memory (RAM), a hard disk, a CD-ROM, and a DVD, or a combination of storage media.

The processor 1230 may control a series of processes such that the UE operates as described above. For example, the transceiver 1210 may receive a data signal including a control signal transmitted by the base station or the network entity, and the processor 1230 may determine a result of receiving the control signal and the data signal transmitted by the base station or the network entity.

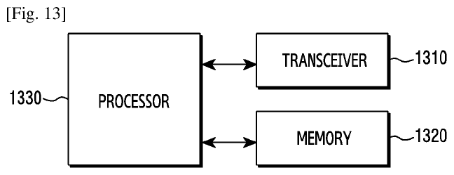

FIG. 13 illustrates a block diagram of a base station, according to embodiments of the present disclosure. FIG. 13 corresponds to the example of the gNB.

As shown in FIG. 13, the base station according to an embodiment may include a transceiver 1310, a memory 1320, and a processor 1330. The transceiver 1310, the memory 1320, and the processor 1330 of the base station may operate according to a communication method of the base station described above. However, the components of the base station are not limited thereto. For example, the base station may include more or fewer components than those described above. In addition, the processor 1330, the transceiver 1310, and the memory 1320 may be implemented as a single chip. Also, the processor 1330 may include at least one processor.

The transceiver 1310 collectively refers to a base station receiver and a base station transmitter, and may transmit/receive a signal to/from a terminal or a network entity. The signal transmitted or received to or from the terminal or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the base station. Also, the memory 1320 may store control information or data included in a signal obtained by the base station. The memory 1320 may be a storage medium, such as read-only memory (ROM), random access memory (RAM), a hard disk, a CD-ROM, and a DVD, or a combination of storage media.

The processor 1330 may control a series of processes such that the base station operates as described above. For example, the transceiver 1310 may receive a data signal including a control signal transmitted by the terminal, and the processor 1330 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for con-venience of explanation and the present disclosure is not limited thereto. As such, an element expressed in a plural form may also be configured as a single element, and an element expressed in a singular form may also be configured as plural elements.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1. A method performed by a transmission device in a wireless communication system, the method comprising:
receiving, from an upper layer, a plurality of service data units (SDU)s;
generating concatenated data by concatenating the plurality of SDUs before performing at least one procedure among an integrity protection procedure and a ciphering procedure for the concatenated data; and
transmitting, to a reception device through a lower layer, data for which the at least one procedure has been performed, at a packet data convergence protocol (PDCP) layer,
wherein common security key information for performing the at least one procedure is applied to the SDUs included in the concatenated data.

2. The method of claim 1, wherein the generating of the concatenated data comprises:
generating a field including information related to the concatenation of the SDUs; and
including the field in a header with the concatenated SDUs in the generated concatenated data.

3. The method of claim 1, wherein the concatenated data is generated in a layer above a Service Data Adaptation Protocol (SDAP) layer or a PDCP layer, and
wherein the concatenation is performed based on a quality of service (QoS) flow identifier (QFI) corresponding to an SDU.

4. The method of claim 1, wherein data from a particular Quality of Service flow is categorised as either data to be used as training data for training an AI model or not.

5. The method of claim 4, wherein both the data categorised as training data and the data not so categorised forms part of User Plane, UP, data.

6. The method of claim 1, wherein data arriving at or departing from an SDAP layer, a Tx and Rx layer respectively, is only partially protected.

7. The method of claim 6, wherein security protection in a PDCP layer is de-configured or disabled.

8. A transmission device in wireless communication system, the transmission device comprising:
a transceiver, and
a controller coupled with the transceiver and configured to:
receive, from an upper layer, a plurality of service data units (SDU)s;
generate concatenated data by concatenating the plurality of SDUs before performing at least one procedure among an integrity protection procedure and a ciphering procedure for the concatenated data; and
transmit, to a reception device through a lower layer, data for which the at least one procedure has been performed, at a packet data convergence protocol (PDCP) layer,
wherein common security key information for performing the at least one procedure is applied to the SDUs included in the concatenated data.

9. The transmission device of claim 8, wherein the controller further configured to:
generate a field including information related to the concatenation of the SDUs; and
include the field in a header with the concatenated SDUs in the generated concatenated data.

10. The transmission device of claim 8, wherein the concatenated data is generated in a layer above a Service Data Adaptation Protocol (SDAP) layer or a PDCP layer, and
wherein the concatenation is performed based on a quality of service (QoS) flow identifier (QFI) corresponding to an SDU.

11. The transmission device of claim 8, wherein data from a particular Quality of Service flow is categorised as either data to be used as training data for training an AI model or not.

12. The transmission device of claim 11, wherein both the data categorised as training data and the data not so categorised forms part of User Plane, UP, data.

13. The transmission device of claim 8, wherein data arriving at or departing from an SDAP layer, a Tx and Rx layer respectively, is only partially protected.

14. The transmission device of claim 12, wherein security protection in a PDCP layer is de-configured or disabled.

15. The transmission device of claim 8 further comprising a base station (BS) and a User Equipment (UE) communicatively connected.
